(19) United States
(12) Patent Application Publication
(10) Pub. No.: US 2024/0179543 A1
(43) Pub. Date: May 30, 2024

(54) COMMUNICATION CONTROL METHOD

(71) Applicant: KYOCERA Corporation, Kyoto (JP)

(72) Inventors: Masato FUJISHIRO, Yokohama-shi (JP); Henry CHANG, San Diego, CA (US)

(73) Assignee: KYOCERA Corporation, Kyoto (JP)

(21) Appl. No.: 18/431,288

(22) Filed: Feb. 2, 2024

Related U.S. Application Data
(63) Continuation of application No. PCT/JP2022/029547, filed on Aug. 1, 2022.
(60) Provisional application No. 63/228,249, filed on Aug. 2, 2021.

(51) Int. Cl. H04W 24/04; H04W 76/19

(52) U.S. Cl. CPC H04W 24/04; H04W 76/19

(57) ABSTRACT

In a first aspect, a communication control method is used in a cellular communication system. The communication control method includes: detecting, by a relay node, an occurrence of a failure in a backhaul link between the relay node and one of parent nodes of a first parent node and a second parent node, the relay node being configured with dual connectivity for the first parent node and the second parent node; and transmitting, by the relay node, a notification relating to detection of the failure to a child node of the relay node, when the relay node is not capable of uplink rerouting.

### RELATED APPLICATIONS

The present application is a continuation based on PCT Application No. PCT/JP2022/029547, filed on Aug. 1, 2022, which claims the benefit of U.S. Provisional Patent Application No. 63/228,249 filed on Aug. 2, 2021. The content of which is incorporated by reference herein in their entirety.

### TECHNICAL FIELD

The present invention relates to a communication control method used in a cellular communication system.

### BACKGROUND OF INVENTION

In the Third Generation Partnership Project (3GPP), which is a project for the standardization of cellular communication systems, introducing a new relay node referred to as an Integrated Access and Backhaul (IAB) node (for example, see “3GPP TS 38.300 V16.2.0 (2020-07)”) is being considered. One or more relay nodes are involved in communication between a base station and a user equipment and perform relay for the communication.

### SUMMARY

In a first aspect, a communication control method is used in a cellular communication system. The communication control method includes: detecting, by a relay node, an occurrence of a failure in a backhaul link between the relay node and one of parent nodes of a first parent node and a second parent node, the relay node being configured with dual connectivity for the first parent node and the second parent node; and transmitting, by the relay node, a notification relating to detection of the failure to a child node of the relay node, when the relay node is not capable of uplink rerouting.

In a second aspect, a communication control method is used in a cellular communication system. The communication control method includes configuring, for a relay node, dual connectivity with a first parent node managing a master cell group as a master node and a second parent node managing a secondary cell group as a secondary node. The communication control method includes not transmitting, by the relay node, a first notification indicating that recovery from a first failure is being attempted, when the first failure occurs in a first backhaul link between the relay node and the first parent node, the first notification. The first parent node is a Long Term Evolution (LTE) node providing an Evolved Universal Terrestrial Radio Access (E-UTRA) service, and the second parent node is a New Radio (NR) node providing a NR service.

In a third aspect, a communication control method is used in a cellular communication system. The communication control method includes detecting, by a relay node, an occurrence of a failure in a backhaul link between the relay node and a parent node of the relay node. The communication control method includes, by the relay node to a child node of the relay node, a notification indicating that recovery from the failure is being attempted and transmitting additional information relating to the notification.

In a fourth aspect, a communication control method is used in a cellular communication system. The communication control method includes receiving, by a relay node from a parent node of the relay node, a notification indicating that a failure has occurred in a backhaul link. The communication control method includes transmitting, by the relay node, the notification to a child node of the relay node in a predetermined case.

### BRIEF DESCRIPTION OF THE DRAWINGS

FIG. 1 is a diagram illustrating a configuration example of a cellular communication system according to an embodiment.

FIG. 2 is a diagram illustrating a relationship between an IAB node, parent nodes, and child nodes.

FIG. 3 is a diagram illustrating a configuration example of a gNB (base station) according to the embodiment.

FIG. 4 is a diagram illustrating a configuration example of an IAB node (relay node) according to the embodiment.

FIG. 5 is a diagram illustrating a configuration example of a UE (user equipment) according to the embodiment.

FIG. 6 is a diagram illustrating an example of a protocol stack related to an RRC connection and a NAS connection of an IAB-MT.

FIG. 7 is a diagram illustrating an example of a protocol stack related to an F1-U protocol.

FIG. 8 is a diagram illustrating an example of a protocol stack related to an F1-C protocol.

FIG. 9 is a diagram illustrating a configuration example of the cellular communication system according to a first embodiment.

FIG. 10A is a diagram illustrating an example of a relationship between IAB nodes 300 according to the first embodiment.

FIG. 10B is a diagram illustrating an example of the relationship between the IAB nodes 300 according to the first embodiment.

FIG. 11 is a flowchart illustrating an operation example according to the first embodiment.

FIG. 12A is a diagram illustrating an EN-DC configuration example according to a second embodiment.

FIG. 12B is a diagram illustrating an EN-DC configuration example according to the second embodiment.

FIG. 13 is a flowchart illustrating an operation example according to the second embodiment.

FIG. 14 is a diagram illustrating an example of a relationship between IAB nodes 300 according to a third embodiment.

FIG. 15 is a flowchart illustrating an operation example according to the third embodiment.

FIG. 16 is a diagram illustrating an example of a relationship between IAB nodes 300 according to a fourth embodiment.

FIG. 17 is a flowchart illustrating an operation example according to the fourth embodiment.

FIG. 18 is a flowchart illustrating an operation example according to a fifth embodiment.

FIG. 19 is a diagram illustrating upstream packet transfer according to a supplementary note.

FIG. 20 is a diagram illustrating an operation of local rerouting according to the supplementary note.

### DESCRIPTION OF EMBODIMENTS

A cellular communication system in an embodiment is described with reference to the drawings. In the description of the drawings, the same or similar parts are denoted by the same or similar reference signs.

Configuration of Cellular Communication System

A configuration example of the cellular communication system according to an embodiment is described. In an embodiment, a cellular communication system 1 is a 3GPP 5G system. Specifically, a radio access scheme in the cellular communication system 1 is New Radio (NR) being a 5G radio access scheme. Note that Long Term Evolution (LTE) may be at least partially applied to the cellular communication system 1. A future cellular communication system such as 6G may be applied to the cellular communication system 1.

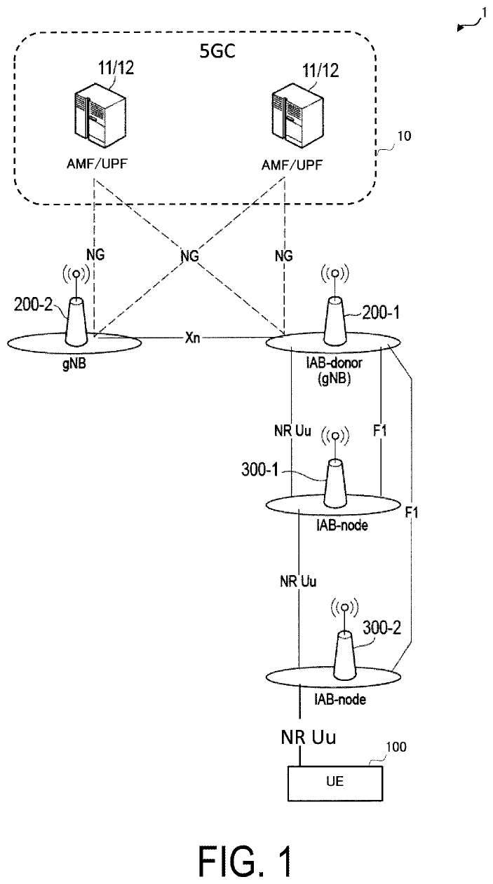

FIG. 1 is a diagram illustrating a configuration example of the cellular communication system 1 according to the embodiment.

As illustrated in FIG. 1, the cellular communication system 1 includes a 5G core network (5GC) 10, a User Equipment (UE) 100, base station apparatuses (hereinafter, also referred to as base stations in some cases) 200-1 and 200-2, and IAB nodes 300-1 and 300-2. The base station 200 may be referred to as a gNB.

An example in which the base station 200 is an NR base station is mainly described below, but the base station 200 may also be an LTE base station (i.e., an eNB).

Note that hereinafter, the base stations 200-1 and 200-2 may be referred to as a gNB 200 (or the base station 200 in some cases), and the IAB nodes 300-1 and 300-2 may be referred to as an IAB node 300.

The 5GC 10 includes an Access and Mobility Management Function (AMF) 11 and a User Plane Function (UPF) 12. The AMF 11 is an apparatus that performs various types of mobility controls and the like for the UE 100. The AMF 11 communicates with the UE 100 by using Non-Access Stratum (NAS) signaling, and thereby manages information of an area in which the UE 100 exists. The UPF 12 is an apparatus that performs transfer control of user data and the like.

Each gNB 200 is a fixed wireless communication node and manages one or more cells. The term “cell” is used to indicate a minimum unit of a wireless communication area. The term “cell” may be used to indicate a function or a resource for performing wireless communication with the UE 100. One cell belongs to one carrier frequency. Hereinafter, the cell and the base station may be used without distinction.

Each gNB 200 is interconnected to the 5GC 10 via an interface referred to as an NG interface. FIG. 1 illustrates a gNB 200-1 and a gNB 200-2 that are connected to the 5GC 10.

Each gNB 200 may be divided into a Central Unit (CU) and a Distributed Unit (DU). The CU and the DU are interconnected via an interface referred to as an F1 interface. An F1 protocol is a communication protocol between the CU and the DU and includes an F1-C protocol that is a control plane protocol and an F1-U protocol that is a user plane protocol.

The cellular communication system 1 supports an IAB that uses NR for the backhaul to enable wireless relay of the NR access. A donor gNB 200-1 (or a donor node, hereinafter also referred to as a “donor node” in some cases) is a donor base station that is a terminal node of an NR backhaul at the network side and includes additional functionality for supporting the IAB. The backhaul can implement multi-hop via a plurality of hops (i.e., a plurality of IAB nodes 300).

FIG. 1 illustrates an example in which the IAB node 300-1 is wirelessly connected to the donor node 200-1, the IAB node 300-2 is wirelessly connected to the IAB node 300-1, and the F1 protocol is transmitted in two backhaul hops.

The UE 100 is a mobile wireless communication apparatus that performs wireless communication with the cells. The UE 100 may be any type of apparatus as long as the UE 100 is an apparatus that performs wireless communication with the gNB 200 or the IAB node 300. For example, the UE 100 includes a mobile phone terminal, a tablet terminal, a laptop PC, a sensor or an apparatus that is provided in a sensor, a vehicle or an apparatus that is provided in a vehicle, and an aircraft or an apparatus provided in an aircraft. The UE 100 is wirelessly connected to the IAB node 300 or the gNB 200 via an access link. FIG. 1 illustrates an example in which the UE 100 is wirelessly connected to the IAB node 300-2. The UE 100 indirectly communicates with the donor node 200-1 via the IAB node 300-2 and the IAB node 300-1.

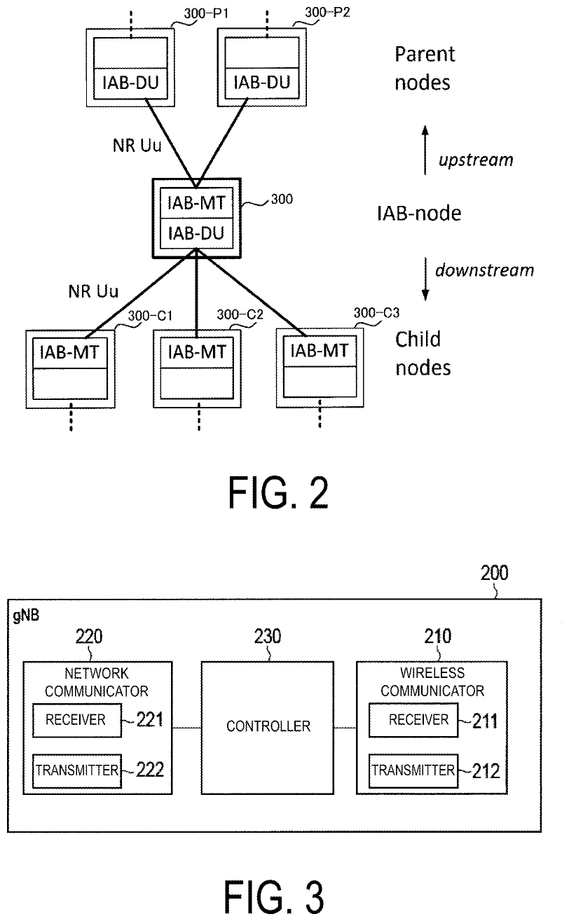

FIG. 2 is a diagram illustrating an example of a relationship between the IAB node 300, parent nodes, and child nodes.

As illustrated in FIG. 2, each IAB node 300 includes an IAB-DU corresponding to a base station functional unit and an IAB-Mobile Termination (MT) corresponding to a user equipment functional unit.

Neighboring nodes of the IAB-MT (i.e., upper node) of an NR Uu wireless interface are referred to as “parent nodes”. The parent node is the DU of a parent IAB node or the donor node 200. A radio link between the IAB-MT and each parent node is referred to as a backhaul link (BH link). FIG. 2 illustrates an example in which the parent nodes of the IAB node 300 are IAB nodes 300-P1 and 300-P2. Note that the direction toward the parent nodes is referred to as upstream. As viewed from the UE 100, the upper nodes of the UE 100 can correspond to the parent nodes.

Neighboring nodes of the IAB-DU (i.e., lower nodes) of an NR access interface are referred to as “child nodes”. The IAB-DU manages cells in a manner the same as, and/or similar to the gNB 200. The IAB-DU terminates the NR Uu wireless interface connected to the UE 100 and the lower IAB nodes. The IAB-DU supports the F1 protocol for the CU of the donor node 200-1. FIG. 2 illustrates an example in which the child nodes of the IAB node 300 are IAB nodes 300-C1 to 300-C3; however, the UE 100 may be included in the child nodes of the IAB node 300. Note that the direction toward the child nodes is referred to as downstream.

### Configuration of Base Station

A configuration of the gNB 200 that is a base station according to the embodiment is described. FIG. 3 is a diagram illustrating a configuration example of the gNB 200. As illustrated in FIG. 3, the gNB 200 includes a wireless communicator 210, a network communicator 220, and a controller 230.

The wireless communicator 210 performs wireless communication with the UE 100 and performs wireless communication with the IAB node 300. The wireless communicator 210 includes a receiver 211 and a transmitter 212. The receiver 211 performs various types of reception under control of the controller 230. The receiver 211 includes an antenna and converts (down-converts) a radio signal received by the antenna into a baseband signal (reception signal) which is then transmitted to the controller 230. The transmitter 212 performs various types of transmission under control of the controller 230. The transmitter 212 includes an antenna and converts (up-converts) the baseband signal (transmission signal) output by the controller 230 into a radio signal which is then transmitted from the antenna.

The network communicator 220 performs wired communication (or wireless communication) with the 5GC 10 and performs wired communication (or wireless communication) with another neighboring gNB 200. The network communicator 220 includes a receiver 221 and a transmitter 222. The receiver 221 performs various types of reception under control of the controller 230. The receiver 221 receives a signal from an external source and outputs the reception signal to the controller 230. The transmitter 222 performs various types of transmission under control of the controller 230. The transmitter 222 transmits the transmission signal output by the controller 230 to an external destination.

The controller 230 performs various types of controls for the gNB 200. The controller 230 includes at least one memory and at least one processor electrically connected to the memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. The processor performs processing of the layers described below. The controller 230 may perform all of the processing and operations in the gNB 200 in each embodiment.

### Configuration of Relay Node

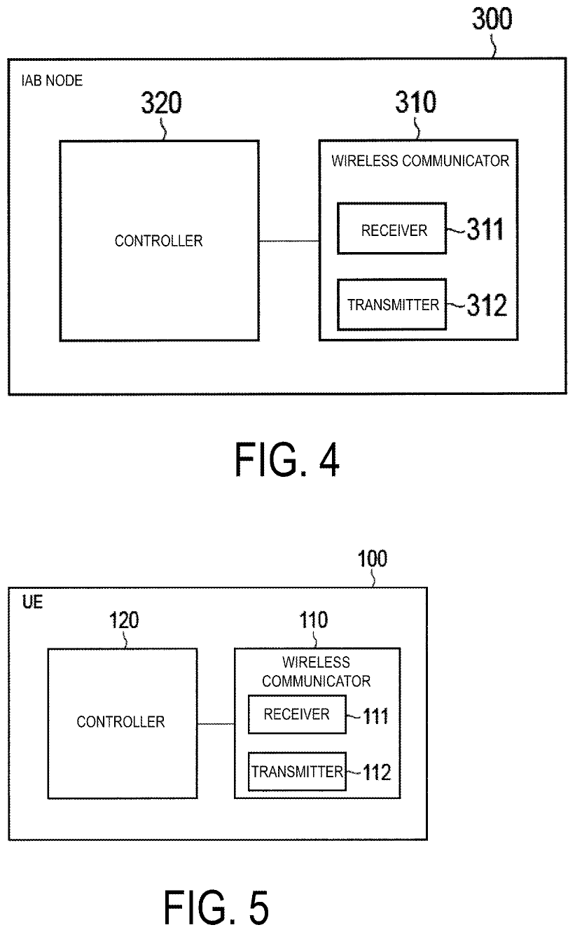

According to the embodiment, a configuration of the IAB node 300 is described that is a relay node (or a relay node apparatus, which is also referred to as a relay node below in some cases). FIG. 4 is a diagram illustrating a configuration example of the IAB node 300. As illustrated in FIG. 4, the IAB node 300 includes a wireless communicator 310 and a controller 320. The IAB node 300 may include a plurality of wireless communicators 310.

The wireless communicator 310 performs wireless communication with the gNB 200 (BH link) and wireless communication with the UE 100 (access link). The wireless communicator 310 for the BH link communication and the wireless communicator 310 for the access link communication may be provided separately.

The wireless communicator 310 includes a receiver 311 and a transmitter 312. The receiver 311 performs various types of reception under control of the controller 320. The receiver 311 includes an antenna and converts (down-converts) a radio signal received by the antenna into a baseband signal (reception signal) which is then transmitted to the controller 320. The transmitter 312 performs various types of transmission under control of the controller 320. The transmitter 312 includes an antenna and converts (up-converts) the baseband signal (transmission signal) output by the controller 320 into a radio signal which is then transmitted from the antenna.

The controller 320 performs various types of controls in the IAB node 300. The controller 320 includes at least one memory and at least one processor electrically connected to the memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. The processor performs processing of the layers described below. The controller 320 may perform all of the processing and operations in the IAB node 300 in each embodiment.

### Configuration of User Equipment

A configuration of the UE 100 that is a user equipment according to the embodiment is described next. FIG. 5 is a diagram illustrating a configuration example of the UE 100. As illustrated in FIG. 5, the UE 100 includes a wireless communicator 110 and a controller 120.

The wireless communicator 110 performs wireless communication in the access link, i.e., wireless communication with the gNB 200 and wireless communication with the IAB node 300. The wireless communicator 110 may also perform wireless communication in a sidelink, i.e., wireless communication with another UE 100. The wireless communicator 110 includes a receiver 111 and a transmitter 112. The receiver 111 performs various types of reception under control of the controller 120. The receiver 111 includes an antenna and converts (down-converts) a radio signal received by the antenna into a baseband signal (reception signal) which is then transmitted to the controller 120. The transmitter 112 performs various types of transmission under control of the controller 120. The transmitter 112 includes an antenna and converts (up-converts) the baseband signal (transmission signal) output by the controller 120 into a radio signal which is then transmitted from the antenna.

The controller 120 performs various types of control in the UE 100. The controller 120 includes at least one memory and at least one processor electrically connected to the memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. The processor performs processing of the layers described below. The controller 130 may perform all of the processing in the UE 100 in each embodiment described below.

### Configuration of Protocol Stack

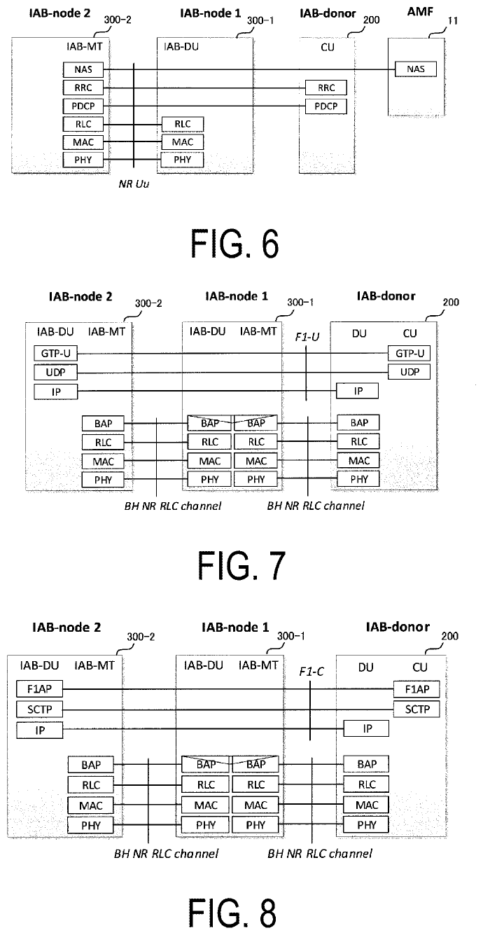

A configuration of a protocol stack according to the embodiment is described next. FIG. 6 is a diagram illustrating an example of a protocol stack related to an RRC connection and a NAS connection of the IAB-MT.

As illustrated in FIG. 6, the IAB-MT of the IAB node 300-2 includes a physical (PHY) layer, a Medium Access Control (MAC) layer, a Radio Link Control (RLC) layer, a Packet Data Convergence Protocol (PDCP) layer, a Radio Resource Control (RRC) layer, and a Non-Access Stratum (NAS) layer.

The PHY layer performs coding and decoding, modulation and demodulation, antenna mapping and demapping, and resource mapping and demapping. Data and control information are transmitted between the PHY layer of the IAB-MT of the IAB node 300-2 and the PHY layer of the IAB-DU of the IAB node 300-1 via a physical channel.

The MAC layer performs preferential control of data, retransmission processing using a hybrid ARQ (HARQ), a random access procedure, and the like. Data and control information are transmitted between the MAC layer of the IAB-MT of the IAB node 300-2 and the MAC layer of the IAB-DU of the IAB node 300-1 via a transport channel. The MAC layer of the IAB-DU includes a scheduler. The scheduler determines the transport format (transport block size, modulation and coding scheme (MCS)) and the assignment of resource blocks in the uplink and the downlink.

The RLC layer transmits data to the RLC layer at the reception side by using functions of the MAC layer and the PHY layer. Data and control information are transmitted between the RLC layer of the IAB-MT of the IAB node 300-2 and the RLC layer of the IAB-DU of the IAB node 300-1 via a logical channel.

The PDCP layer performs header compression and decompression, and encryption and decryption. Data and control information are transmitted between the PDCP layer of the IAB-MT of the IAB node 300-2 and the PDCP layer of the donor node 200 via a radio bearer.

The RRC layer controls a logical channel, a transport channel, and a physical channel according to establishment, re-establishment, and release of a radio bearer. RRC signaling for various configurations is transmitted between the RRC layer of the IAB-MT of the IAB node 300-2 and the RRC layer of the donor node 200. When an RRC connection to the donor node 200 is present, the IAB-MT is in an RRC connected state. When no RRC connection to the donor node 200 is present, the IAB-MT is in an RRC idle state.

The NAS layer which is positioned upper than the RRC layer performs session management, mobility management, and the like. NAS signaling is transmitted between the NAS layer of the IAB-MT of the IAB node 300-2 and the AMF 11.

FIG. 7 is a diagram illustrating a protocol stack related to an F1-U protocol. FIG. 8 is a diagram illustrating a protocol stack related to an F1-C protocol. An example is illustrated in which the donor node 200 is divided into a CU and a DU.

As illustrated in FIG. 7, each of the IAB-MT of the IAB node 300-2, the IAB-DU of the IAB node 300-1, the IAB-MT of the IAB node 300-1, and the DU of the donor node 200 includes a Backhaul Adaptation Protocol (BAP) layer as a higher layer of the RLC layer. The BAP layer performs routing processing, and bearer mapping and demapping processing. In the backhaul, the IP layer is transmitted via the BAP layer to allow routing through a plurality of hops.

In each backhaul link, a Protocol Data Unit (PDU) of the BAP layer is transmitted by the backhaul RLC channel (BH NR RLC channel). Configuring each BH link to include a plurality of backhaul RLC channels enables the prioritization and QoS control of traffic. The association between the BAP PDU and the backhaul RLC channel is executed by the BAP layer of each IAB node 300 and the BAP layer of the donor node 200.

As illustrated in FIG. 8, the protocol stack of the F1-C protocol includes an F1AP layer and an SCTP layer instead of a GTP-U layer and a UDP layer illustrated in FIG. 7.

Note that in the description below, processing or operation performed by the IAB-DU and the IAB-MT of the IAB may be simply described as processing or operation of the “IAB”. For example, in the description, transmitting, by the IAB-DU of the IAB node 300-1, a message of the BAP layer to the IAB-MT of the IAB node 300-2 is assumed to correspond to transmitting, by the IAB node 300-1, the message to the IAB node 300-2. Processing or operation of the DU or CU of the donor node 200 may be described simply as processing or operation of the “donor node”.

An upstream direction and an uplink (UL) direction may be used without distinction. A downstream direction and a downlink (DL) direction may be used without distinction.

### First Embodiment

A first embodiment is described.

First, in the first embodiment, a Type 2 BH RLF Indication and local rerouting are described.

### Type 2 BH RLF Indication

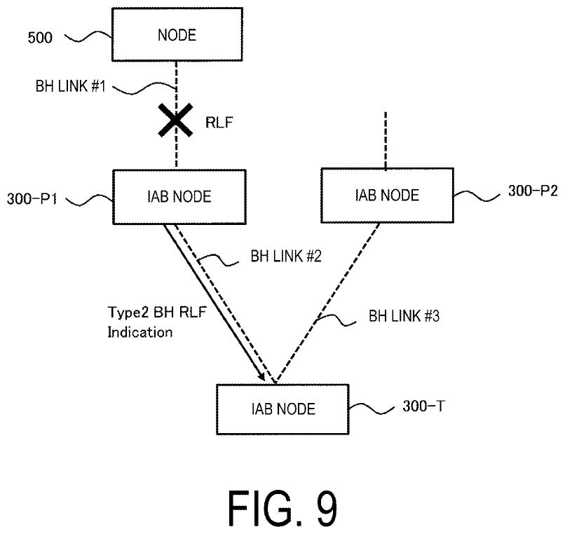

FIG. 9 is a diagram illustrating a configuration example of a cellular communication system 1 according to the first embodiment.

The cellular communication system 1 illustrated in FIG. 9 includes a node 500, the parent node 300-P1, the parent node 300-P2, and an IAB node 300-T.

The node 500 is a parent node of the IAB node 300-P1, which is the donor node 200 or the IAB node 300 (parent IAB node). The IAB-MT of the IAB node 300-P1 has established a backhaul link (BH link) #1 with the node 500.

The IAB node 300-T is a child node (or a child IAB node) of the IAB node 300-P1. The IAB-MT of the IAB node 300-T has established a BH link #2 with the IAB node 300-P1. Note that the IAB-MT of the IAB node 300-T has established a BH link #3 with the IAB node 300-P2. The IAB node 300-P2 is a parent node of the IAB node 300-T.

Assume that in such a configuration, the IAB-MT of the IAB node 300-P1 detects a Radio Link Failure in the BH link #1 (BH RLF). The IAB-MT of the IAB node 300-P1 detects the BH RLF, for example, as follows, and makes a recovery attempt to recover from the BH RLF.

First, when detecting an out-of-sync state N310 consecutive times, the IAB-MT of the IAB node 300-P1 starts a timer T310. When detecting an in-sync state N311 consecutive times after the start of the timer T310, the IAB-MT of the IAB node 300-P1 stops the timer T310. When the timer T310 expires without being stopped, the IAB-MT of the IAB node 300-P1 detects a radio link failure (RLF) of the BH link #1.

Second, the IAB-MT of the IAB node 300-P1 detects the RLF and starts a timer T311 (i.e., starts an RRC reestablishment processing), and performs cell selection processing in order to recover the BH link. When selecting an appropriate cell by the cell selection processing and recovering the BH link for the selected cell, the IAB-MT of the IAB node 300-P1 stops the timer T311. The appropriate cell refers to a cell that satisfies at least minimum radio quality standards.

Third, when the recovery of the BH link #1 is unsuccessful and the timer T311 expires, the IAB-MT of the IAB node 300-P1 transitions to the RRC idle state. Failed recovery from a BH RLF after detection of the BH RLF (i.e., expiration of the timer T311) may be hereinafter referred to as failed recovery of BH link.

Here, the IAB-DU of the IAB node 300-P1, when detecting the BH RLF, can notify the IAB-MT of the IAB node 300-T of a Type 1 BH RLF Indication (hereinafter also referred to as a “Type 1 Indication” in some cases). The Type 1 Indication is an example of a failure occurrence notification indicating the detection of a BH RLF.

When detecting an operation of recovering from the BH RLF, the IAB-DU of the IAB node 300-P1 can notify the IAB-MT of the IAB node 300-T of the Type 2 BH RLF Indication (hereinafter also referred to as the “Type 2 Indication” in some cases). The Type 2 Indication is an example of a failure occurrence notification indicating that the recovery from the BH RLF is being attempted.

Further, when not distinguishing between the Type 1 Indication and the Type 2 Indication, the IAB-DU of the IAB node 300-P1 can transmit a Type 1/2 BH RLF Indication (hereinafter also referred to as the “Type 1/2 Indication” in some cases) to the IAB-MT of the IAB node 300-T. The Type 1/2 indication is also an example of the failure occurrence notification.

Note that the Type 1 Indication may be replaced with the Type 2 Indication. The Type 1 Indication is transmitted when a BH RLF is detected, and the Type 2 Indication is transmitted when a recovery attempt is made. However, the IAB-MT of the IAB node 300-P1 makes the recovery attempt processing of the BH RLF immediately after detecting the BH RLF. Therefore, two Indications can be regarded as substantially the same Indication.

A recovery notification indicating that the BH link has recovered from the BH RLF is also present. Such a recovery notification is referred to as a Type 3 BH RLF Indication (hereinafter also referred to as a “Type 3 Indication” in some cases). A failure notification indicating that the BH link has failed to recover from the RLF is also present. Such a failure notification is referred to as a Type 4 BH RLF Indication (hereinafter also referred to as a “Type 4 Indication” in some cases).

FIG. 9 illustrates an example in which the IAB node 300-P1 transmits the Type 2 Indication to the IAB node 300-T that is a child node of the IAB node 300-P1.

### Local Rerouting

As described above, in a network including a plurality of IAB nodes 300, a BH RLF may occur in a backhaul link between the IAB nodes 300.

In a multi-hop network where packets are transferred by a plurality of IAB nodes 300 one after another, data packets may be transferred to a destination IAB node 300 (or donor node 200) via an alternative path. Transferring the data packet using the alternative path may be referred to as local rerouting. The local rerouting may be performed by selecting an alternative path, while ignoring a routing configuration provided by the donor node 200. Alternatively, the local rerouting may be performed by selecting an alternative path from alternative path candidates configured by the donor node 200.

The example illustrated in FIG. 9 represents the IAB node 300-T performing local rerouting to the parent node 300-P2 on the alternative path.

### Communication Control Method According to First Embodiment

3GPP agreed that the Type 2 Indication is generated when a BH RLF (hereinafter, also referred to as an “RLF” in some cases) is detected.

However, the IAB node 300 may not need to transmit the Type 2 Indication even when detecting an RLF. Alternatively, the IAB node 300 may delete the generated Type 2 indication from the memory even when detecting an RLF.

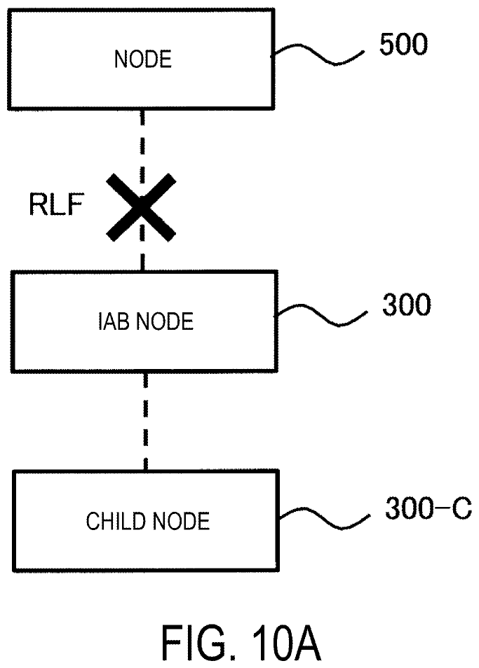

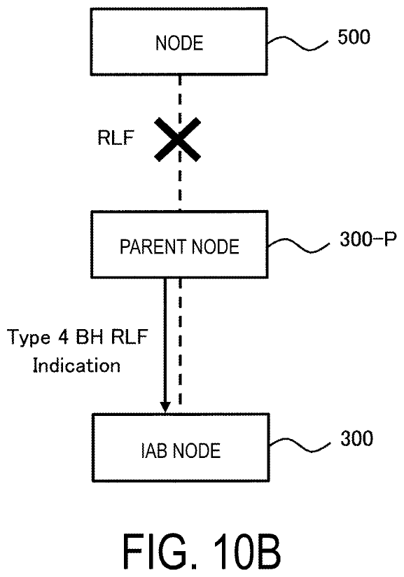

FIG. 10A is a diagram illustrating an example of a relationship between the IAB nodes 300 according to the first embodiment. As illustrated in FIG. 10A, assume that the IAB node 300 detects an RLF in the BH link with the parent node 500. Additionally, assume that in the IAB node 300, dual connectivity (DC) is configured for the parent node 500 and other parent nodes than the parent node.

In this case, the IAB node 300 itself has an alternate path (or transferring path) to another parent node. Therefore, the IAB node 300 can transfer the data packet received from the child node 300-C by using the alternative path. Therefore, even when the IAB node 300 detects the RLF by itself, the IAB node 300 may not need to transmit the Type 2 Indication to the child node 300-C of the IAB node 300.

On the other hand, the child node 300-C receiving the Type 2 Indication may perform processing such as the local rerouting in response to the reception of the Type 2 Indication from the IAB node 300. However, the child node 300-C performs processing such as the local rerouting even though the alternate path is ensured by the IAB node 300. Therefore, redundant processing may be performed in the child node 300-C.

As such, in the first embodiment, when the local rerouting is possible in the IAB node 300, the Type 2 Indication is not transmitted even when the RLF is detected.

Specifically, first, the relay node (e.g., the IAB node 300) detects an occurrence of a failure in the backhaul link. Second, when the relay node is capable of local rerouting to transfer the data packet to the alternate path, the relay node does not transmit a notification (e.g., the Type 2 Indication) indicating that recovery from the failure is being attempted to a child node (e.g., the child node 300-C) of the relay node. On the other hand, when incapable of the local rerouting, the relay node transmits the notification to the child node.

Accordingly, the IAB node 300 may sometimes not transmit the Type 2 Indication to the child node 300-C even when detecting the RLF, and thus the redundant processing can be suppressed in the child node 300-C.

### Operation Example of First Embodiment

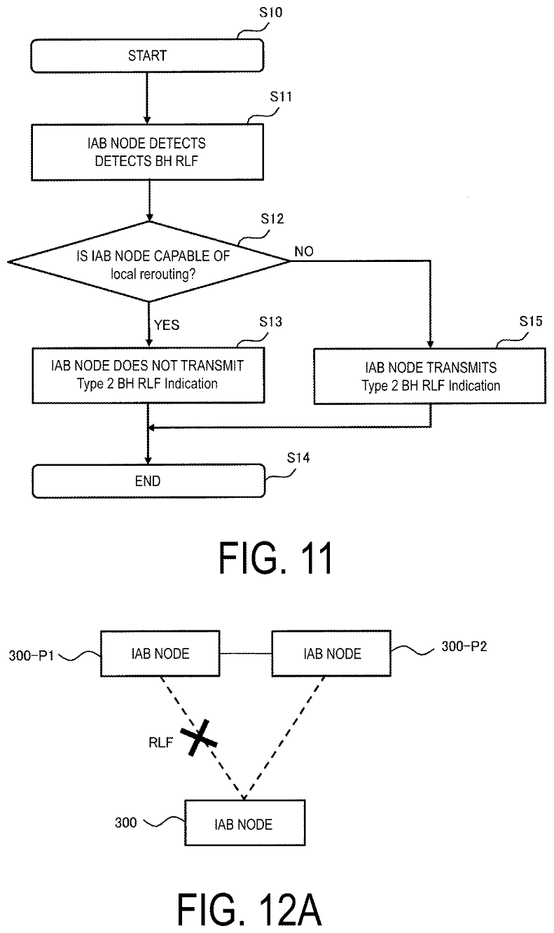

In the first embodiment, an operation example is described. FIG. 11 is a diagram illustrating an operation example according to the first embodiment.

As illustrated in FIG. 11, in step S10, the IAB node 300 starts processing.

In step S11, the IAB node 300 detects a BH RLF. First, as illustrated in FIG. 10A, the IAB node 300 itself may detect the RLF in the BH link with the parent node 500. In this case, the RLF detection method described in “Type 2 BH RLF Indication” may be used for the RLF detection. Second, the IAB node 300 may detect the RLF when the IAB node 300 receives the Type 4 Indication from the parent node. FIG. 10B is a diagram illustrating an example of the relationship between the IAB nodes 300 according to the first embodiment. As illustrated in FIG. 10B, the IAB node 300 may detect the RLF when the IAB node 300 receives the Type 4 Indication from the parent node 300-P.

Returning to FIG. 11, in step S12, the IAB node 300 determines whether being capable of the local rerouting.

First, whether being capable of the local rerouting may be determined depending on whether DC is configured for the IAB-MT of the IAB node 300. This is because when DC is configured for the IAB node 300 as described above, a path different from the path in which RLF has occurred can be set as the alternative path. Whether DC is configured for the IAB node 300 may be determined based on whether configuration information is received from the parent node that is a master node. The IAB-MT of the IAB node 300 may determine to be capable of the local rerouting when DC is configured, and may determine to be not capable of the local rerouting when DC is not configured. Whether being capable of the local rerouting may be determined based on whether a secondary cell group is activated in the IAB-MT of the IAB node 300. The IAB-MT of the IAB node 300 may determine to be capable of the local rerouting when the secondary cell group is activated, and may determine to be not capable of the local rerouting when the secondary cell group is deactivated.

Second, whether being capable of the local rerouting may be determined based on (1) whether an alternative route (or an alternative path) exists and (2) whether the alternative route is selectable. Specifically, when an alternative route exists and the alternative route is selectable, the IAB-MT of the IAB node 300 determines to be capable of the local rerouting. On the other hand, when no alternative route exists, or when an alternative route exists but the alternative route is not selectable, the IAB-MT of the IAB node 300 determines to be not capable of the local rerouting.

(1) Whether an alternative route exists may be determined as follows. Specifically, the IAB-MT of the IAB node 300 may make the determination depending on whether another route (another routing ID) exists that has a destination BAP address (Destination) the same as the destination BAP address (Destination) of a route (routing ID) to be locally rerouted. In other words, the IAB node 300 determines whether an alternative path exits depending on whether there is a route that is different from a route to be locally rerouted and has the same destination. Alternatively, the IAB node 300 may determine whether an alternative route exists depending on whether an alternative route (another routing ID) is configured by the donor node 200 for a route (routing ID) to be locally rerouted. Note that the routing ID includes a destination BAP address (Destination) and a path identifier (Path ID).

(2) On the other hand, whether the alternative route is selectable may be determined as follows. Specifically, the IAB-MT of the IAB node 300 may make the determination depending on whether an egress link associated with a candidate for the alternative route that is confirmed to exist in (1) is available. In this case, when the egress link associated with the candidate is available, the IAB-MT of the IAB node 300 determines that the candidate route is selectable as an alternative route. On the other hand, when the egress link is not available, the IAB-MT of the IAB node 300 determines that the candidate route is not selectable as an alternative route.

Note that whether being capable of the local rerouting may be determined depending on whether all traffics can be locally rerouted. For example, when some traffics cannot be locally rerouted, the IAB-MT of IAB node 300 may determine to be not capable of the local rerouting.

The IAB node 300, when determining to be capable of the local rerouting (YES in step S12), does not transmit the Type 2 Indication in step S13. This is because when the IAB node 300 is capable of the local rerouting, the IAB node 300 can transfer the data packet transferred from the child node to the alternate path without transmitting the Type 2 Indication to the child node of the IAB node 300. In this case, the IAB-DU of the IAB node 300 may delete the generated Type 2 Indication from the memory. The IAB-DU of the IAB node 300 may cancel transmission of the generated Type 2 Indication.

In step S14, the IAB node 300 terminates a series of processing operations.

On the other hand, the IAB node 300, when determining to be not capable of the local rerouting (NO in step S12), transmits the Type 2 Indication to the child node 300-C of the IAB node 300 in step S15. The IAB-DU of the IAB node 300 transmitting the Type 2 Indication to the child node 300-C allows the child node 300-C to perform the local rerouting.

Then, in step S14, the IAB node 300 terminates a series of processing operations.

### Second Embodiment

One type of DC is an Evolved Universal Terrestrial Radio Access (E-UTRA)-NR Dual Connectivity (EN-DC). Here, EN-DC is described.

### EN-DC

In EN-DC, the UE 100 is connected to one evolved Node B (eNB) serving as a master node and one en-gNB serving as a secondary node. The eNB is an LTE base station providing an E-UTRA service. The en-gNB is an NR base station providing an NR service.

For example, when EN-DC is configured for the IAB node 300, the master node may be a first parent node (eNB) of the IAB node 300 and the secondary node may be a second parent node (en-gNB) of the IAB node 300.

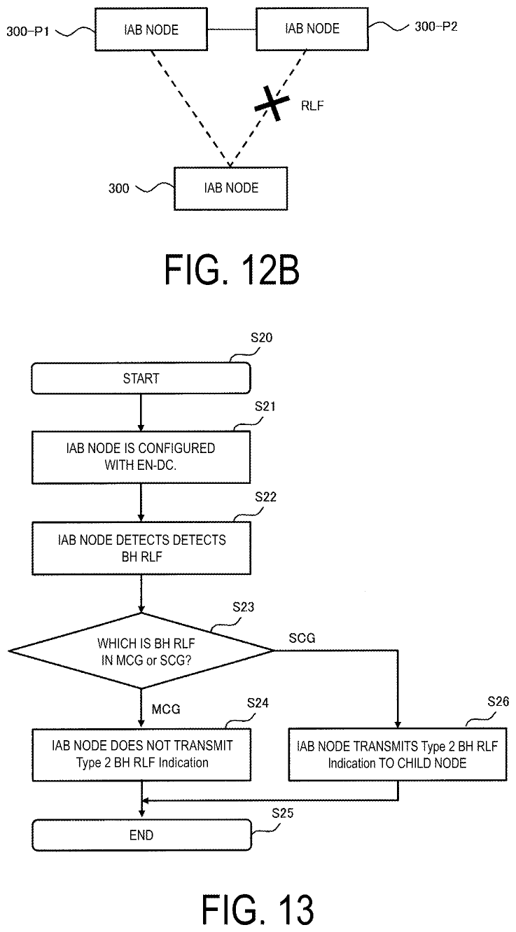

FIGS. 12A and 12B are diagrams illustrating an EN-DC configuration example according to a second embodiment. FIGS. 12A and 12B illustrate an example in which EN-DC is configured for the IAB node 300 with the master node as the IAB node 300-P1 and the secondary node as the IAB node 300-P2.

The master node (IAB node 300-P1) manages a master cell group (MCG). The MCG is a cell group of serving cells associated with the master node (IAB node 300-P1). On the other hand, the secondary node (IAB node 300-P2) manages the secondary cell group (SCG). The SCG is a cell group of serving cells associated with the secondary node (IAB node 300-P2).

In EN-DC, the MCG performs processing related to control. On the other hand, the SCG performs processing related to data. Therefore, as illustrated in FIG. 12A, even when an RLF occurs in the backhaul between the IAB node 300 and the master node (IAB node 300-P1) managing the MCG, there is little influence on a data path, routing, or the like.

On the other hand, as illustrated in FIG. 12B, when an RLF occurs in the backhaul between the IAB node 300 and the secondary node (IAB node 300-P2) managing the SCG, this directly results in the data path being lost and the routing not being able to be performed because the SCG performs the processing related to data.

### Communication Control Method According to Second Embodiment

3GPP agreed that the IAB node 300 with the dual parent nodes (via DC) may trigger the local rerouting to one parent node when receiving the Type 2 Indication from the other parent node.

However, as described above, when EN-DC is configured, the influence on data relay greatly varies depending in which backhaul an RLF has occurred. Therefore, regarding the transmission of the Type 2 Indication also, the IAB node 300 may not need to transmit the Type 2 Indication even when the RLF occurs, in some cases.

In other words, for the IAB node 300, even when the RLF occurs at the MCG side, the alternative path is ensured at the SCG side, and thus, the data packet transferred from the child node can be transferred by using the alternative path. In such a case, even when the IAB node 300 transmits the Type 2 Indication to the child node, the child node may perform processing such as the local rerouting even though the alternate path is ensured by the IAB node 300. Such processing of the child node may be redundant processing the same as, and/or similar to in the first embodiment.

Therefore, in the second embodiment, the IAB node 300 configured with EN-DC does not transmit the Type 2 indication even when an RLF occurs in the backhaul between the IAB node 300 and the first parent node managing the MCG. On the other hand, when an RLF occurs in the backhaul between the IAB node 300 and the second parent node managing the SCG, the IAB node 300 transmits the Type 2 Indication to the child node of the IAB node 300.

To be more specific, first, the relay node (e.g., the IAB node 300) is configured with dual connectivity with the first parent node (e.g., the IAB node 300-P1) managing the master cell group as the master node and the second parent node (e.g., the IAB node 300-P2) managing the secondary cell group as the secondary node. Second, the relay node does not transmit a first notification (e.g., Type 2 Indication), when a first failure occurs in a first backhaul link between the relay node and the first parent node, the first notification indicating that recovery from the first failure is being attempted. Here, the first parent node is an LTE node (or an LTE base station) providing an E-UTRA service, and the second parent node is an NR node (or an NR base station) providing an NR service.

Accordingly, in a manner the same as, and/or similar to in the first embodiment, the IAB node 300 may sometimes not transmit the Type 2 Indication to the child node, and thus the redundant processing can be suppressed for the child node.

### Operation Example of Second Embodiment

FIG. 13 is a diagram illustrating an operation example according to the second embodiment.

As illustrated in FIG. 13, in step S20, the IAB node 300 starts processing.

In step S21, the IAB node 300 is configured with EN-DC. For example, the IAB node 300 receives an RRC connection reconfiguration (RRCConnectionReconfiguration) message including configuration information for EN-DC from the IAB node 300-P1 that is the master node, and thereby, is configured with EN-DC.

In step S22, the IAB node 300 detects a BH RLF. The IAB-MT of the IAB node 300 may detect an RLF in the BH link between the IAB node 300 and the IAB node 300-P1 that is the master node. The IAB-MT of the IAB node 300 may detect an RLF in the BH link between the IAB node 300 and the IAB node 300-P2 that is the secondary node. The detection of the RLF itself may be the same as in step S11 in the first embodiment.

In step S23, the IAB node 300 determines whether the RLF has occurred in the MCG or the RLF has occurred in the SCG. For example, the IAB-MT of the IAB node 300, when detecting an RLF in the BH link between the IAB node 300 and the IAB node 300-P1, determines that the RLF has occurred in the MCG. For example, the IAB-MT of the IAB node 300, when detecting an RLF in the BH link between the IAB node 300 and the IAB node 300-P2, determines that the RLF has occurred in the SCG.

The IAB node 300, when determining that the RLF has occurred in the MCG (“MCG” in step S23), does not transmit the Type 2 Indication in step S24. This is because even when the RLF occurs in the MCG, when a path to the IAB node 300-P2 that is the secondary node is ensured, the data packet received from the child node can be transferred to the path. In this case, the IAB node 300 may delete the generated Type 2 Indication from the memory. The IAB node 300 may cancel transmission of the generated Type 2 Indication.

Then in step S25, the IAB node 300 terminates a series of processing operations.

On the other hand, when an RLF occurs in the SCG (“SCG” in step S23), the IAB node 300 transmits the Type 2 Indication to the child node of the IAB node 300 in step S26. Since a path for transferring the data packet is not ensured by the IAB node 300, the IAB-DU of the IAB node 300 transmitting the Type 2 Indication to the child node allows the child node to perform the local rerouting.

Then in step S25, the IAB node 300 terminates a series of processing operations.

### Third Embodiment

A third embodiment is described.

When the IAB node 300 transmits the Type 2 Indication to the child node 300-C, various controls may be performed in the child node 300-C in response to reception of the Type 2 Indication in the future. For example, one example of such controls is that the IAB node 300-C having dual parent nodes may perform the local rerouting when receiving the Type 2 Indication.

Therefore, in the third embodiment, the IAB node 300 transmits additional information together with the Type 2 Indication to the child node 300-C of the IAB node. Alternatively, the IAB node 300 transmits the Type 2 Indication including the additional information to the child node 300-C.

Specifically, first, the relay node (e.g., the IAB node 300) detects an occurrence of a failure in the backhaul link between the relay node and the parent node (e.g., the IAB node 300-P) of the relay node. Second, the relay node transmits a notification (for example, the Type 2 Indication) indicating that recovery from the failure is being attempted to the child node (for example, the IAB node 300-C) of the relay node, and transmits the additional information related to the notification.

Accordingly, for example, the child node 300-C receiving the additional information together with the Type 2 Indication can perform various controls related to the Type 2 Indication in accordance with the additional information.

Note that in the following description, the transmission of the additional information together with the Type 2 Indication and the transmission of the Type 2 Indication including the additional information may be used without distinction.

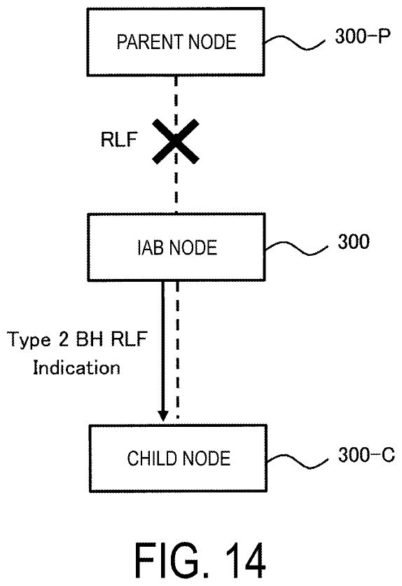

FIG. 14 is a diagram illustrating an example of a relationship between the IAB nodes 300 according to the third embodiment. The first and second embodiments described that the IAB node 300 may sometimes not transmit the Type 2 indication. The third embodiment, as illustrated in FIG. 14, describes that when an RLF occurs in the BH link between the IAB node 300 and the parent node 300-P, the IAB node 300 transmits the Type 2 Indication to the child node 300-C of the IAB node 300.

### Operation Example of Third Embodiment

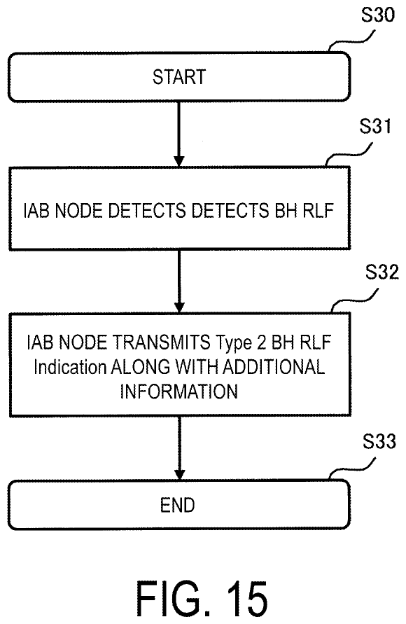

FIG. 15 is a flowchart illustrating an operation example according to the third embodiment. As illustrated in FIG. 15, in step S30, the IAB node 300 starts processing.

In step S31, the IAB node 300 detects an RLF in the BH link between the IAB node 300 and the parent node 300-P. The detection method may be the same as, and/or similar to that in the first embodiment (step S11 in FIG. 11).

In step S32, the IAB node 300 transmits the Type 2 Indication together with the additional information to the child node 300-C.

The additional information may be information related to the Type 2 Indication. The additional information includes following five types, for example.

A1: The additional information is information indicating whether the node (the IAB node 300) itself is capable of the local rerouting.

A2: The additional information is information indicating whether the child node 300-C is to perform the local rerouting.

A3: The additional information is information indicating in which one of the MCG and the SCG an RLF has occurred, or the additional information is information indicating which of the MCG and the SCG is available.

A4: The additional information is information indicating an available (or unavailable) routing ID.

A5: The additional information is information indicating quality of an available link.

Hereinafter, A1 to A5 are described in order.

### A1

The additional information may be information indicating whether the node (the IAB node 300) itself is capable of the local rerouting.

For example, in the example of FIG. 14, the child node 300-C, when receiving from the IAB node 300, together with the Type 2 Indication, the additional information indicating that the IAB node 300 is capable of the local rerouting, can transmit the data packet to the IAB node 300. This is because the child node 300-C can transfer the data packet to the destination node by using the alternative path of the IAB node 300 even when an RLF occurs. On the other hand, the child node 300-C, when receiving, together with the Type 2 Indication, the additional information indicating that the IAB node 300 is not capable of the local rerouting, may perform the local rerouting by itself.

### A2

The additional information may be information indicating whether the child node 300-C is to perform the local rerouting.

For example, since the IAB node 300 (the parent node of the child node 300-C) cannot perform the local rerouting by itself, the additional information may be for indicating that the child node 300-C performs the local rerouting. For example, since the IAB node 300 can perform the local rerouting by itself, the additional information may be for indicating that the child node 300-C is not to perform the local rerouting.

The child node 300-C, when receiving the additional information indicating that the child node 300-C is to perform the local rerouting, performs the local rerouting in accordance with the additional information. On the other hand, the child node 300-C, when receiving the additional information indicating that the child node 300-C is not to perform the local rerouting, does not perform the local rerouting according to the additional information even when receiving the Type 2 Indication. In this case, the child node 300-C may transmit the data packet to IAB node 300.

### A3

The additional information may be information indicating in which one of the MCG and the SCG an RLF has occurred in, or the additional information may be information indicating which of the MCG and the SCG is available.

To be more specific, the additional information may be information indicating in which one of the first backhaul link and a second backhaul a failure has occurred, the first backhaul link being between the first parent node (e.g., the parent node 300-P1) managing the MCG and the relay node (e.g., the IAB node 300), the second backhaul link being between the second parent node (e.g., the parent node 300-P2) managing the SCG and the relay node. Alternatively, the additional information may be information indicating which one of the first backhaul link and the second backhaul link is available.

The child node 300-C, when receiving the additional information indicating in which one of the MCG and the SCG an RLF has occurred, may determine that the route to the cell group in which the RLF has occurred is unavailable and may perform the local rerouting on the traffic to the route. Alternatively, the child node 300-C, when receiving the additional information indicating which one of the MCG and the SCG is available, may select a route to an available cell group as an alternative route.

Note that the IAB node 300 may determine whether an RLF has occurred in either the MCG or the SCG depending on whether an RLF has occurred in the BH link with the parent node 300-P1 managing the MCG or an RLF has occurred in the BH link with the parent node 300-P2 managing the SCG.

In this case, the IAB node 300 may determine a cell group in which an RLF does not occur as an available cell group.

Note that a correspondence relationship between the route to each cell group (MCG or SCG) and the routing ID may be notified from the donor node 200 in advance. In other words, the child node 300-C may confirm the cell group in which the RLF has occurred by the additional information. The child node 300-C can confirm the routing ID corresponding to the cell group in which the RLF has occurred by the notification from the donor node 200. The child node 300-C can set the data packet including the routing ID as a target to be locally rerouted.

### A4

The additional information may be information indicating an available (or unavailable) routing ID.

For example, the IAB node 300 may be configured with DC to have a routable path or configured in advance from the donor node 200 to have a routable path.

When the IAB node 300 detects an RLF and has a routable path other than a path in which the RLF has occurred, the IAB node 300 may transmit the routing ID of the routable path to the child node 300-C as the additional information indicating an available routing ID. On the other hand, when a path other than a path in which the RLF has occurred is unavailable, the IAB node 300 may transmit the additional information indicating an unavailable routing ID to the child node 300-C.

The child node 300-C, when receiving the additional information indicating the available routing ID together with the Type 2 Indication, may transfer the data packet including the routing ID to the IAB node (parent node) 300. This is because the IAB node 300 has the alternative path in which the local rerouting can be performed even when an RLF occurs, and thus the IAB node 300 can transmit the data packet using the alternative path.

On the other hand, the child node 300-C, when receiving the additional information indicating the unavailable routing ID together with the Type 2 Indication, performs the local rerouting on the data packet including the routing ID. In this case, even when the child node 300-C transfers the data packet to the IAB node (parent node) 300, the child node 300-C performs the local rerouting by itself since the IAB node 300 has no available path. In this way, the additional information indicating the unavailable routing ID may be interpreted as a routing ID for which the child node 300-C is to perform the local rerouting.

Note that for (A4), an available or unavailable destination BAP address (Destination) may be used as the additional information instead of the available or unavailable routing ID.

An available path ID or an unavailable path ID may be used as the additional information instead of the available or unavailable routing ID. Since the routing ID includes a destination BAP address (Destination) and a path ID, the destination address or the path ID can be used for the additional information instead of the routing ID.

### A5

The additional information may be information indicating quality of an available link.

For example, assume that the IAB node 300 performs the local rerouting from the SCG to the MCG. In this case, congestion may occur in the BH link to the MCG after the routing. Even when a data packet is transferred to the BH link where congestion occurs, a delay occurs.

Therefore, when an RLF occurs in the BH link to the SCG, the IAB node 300 transmits the additional information indicating the quality of the MCG to the child node 300-C together with the Type 2 Indication.

Accordingly, for example, the child node 300-C can know the quality status of the alternative path candidate in the IAB node (parent node) 300. Then, the child node 300-C can perform the local rerouting by itself in accordance with the quality status. This allows, for example, the child node 300-C to not perform transferring to the alternative path candidate, and can also suppress a situation in which a delay occurs due to congestion in advance.

The quality may be a throughput, congestion situation, or delay of the available link. The quality may be a throughput, congestion situation, or delay after the occurrence of the RLF in the available link. The quality may be a difference (or a ratio) between the throughput, the congestion state, or the delay before the occurrence of the RLF in the available link and the throughput, the congestion state, or the delay after the occurrence of the RLF, respectively.

Note that the child node 300-C, when receiving the additional information indicating the quality of the available link, performs the local rerouting or transfers the data packet to the IAB node 300 in accordance with the additional information. For example, the child node 300-C may locally reroute some traffic and transfer the data packet to a parent node other than IAB node 300, depending on the quality.

Returning to FIG. 15, in step S33, the IAB node 300 terminates a series of processing operations.

### Variation of Third Embodiment

A variation of the third embodiment is described. The variation of the third embodiment is as below, for example. Specifically, the IAB node 300 can transmit the additional information obtained by combining all or a part of A1 to A5. For example, the IAB node 300 may transmit the information (A1) indicating that the IAB node 300 is capable of the local rerouting and the information (A4) indicating an available routing ID together with the Type 2 Indication.

3GPP agreed that the Type 2 Indication and the Type 3 Indication are transmitted in a BAP Control PDU. Therefore, the additional information may also be transmitted in the BAP Control PDU. In this case, the Type 2 indication and the additional information may be included in one BAP control PDU. The Type 2 Indication and the additional information may be included in separate BAP control PDUs. The additional information may be transmitted by a MAC Control Element (CE) or the like instead of the BAP Control PDU.

### Fourth Embodiment

A fourth embodiment is described.

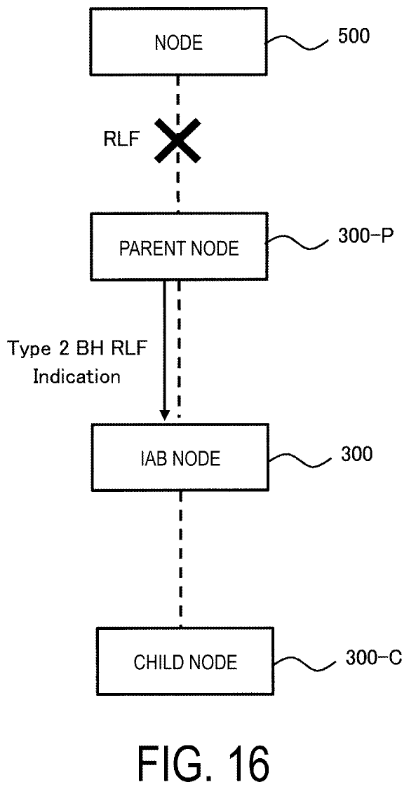

FIG. 16 is a diagram illustrating an example of a relationship between the IAB nodes 300 according to a fourth embodiment.

3GPP has discussed propagation of the Type 2 Indication. The propagation of the Type 2 Indication means that the IAB node 300 that receives the Type 2 Indication from the parent node 300-P transmits (or transfers) the Type 2 Indication to the child node 300-C of the IAB node 300.

Since the propagation of the Type 2 indication causes an alternative path to be ensured through the processing of local rerouting or the like, restoring the service more quickly in the entire topology is considered to be possible.

However, conceivable problems may include whether the propagation of the Type 2 Indication may be always performed, whether the propagation of the Type 2 Indication may be performed by one hop, or whether the propagation of the Type 2 Indication itself need not be performed.

Therefore, in the fourth embodiment, the IAB node 300, when receiving the Type 2 Indication and when being incapable of performing the local rerouting, performs the propagation of the Type 2 Indication.

To be more specific, first, the relay node (e.g., the IAB node 300) receives a notification (e.g., the Type 2 Indication) indicating that a failure has occurred in a backhaul link from the parent node (the parent node 300-P) of the relay node. Second, the relay node transmits the notification to the child node (e.g., the child node 300-C) of the relay node in a predetermined case. Here, the predetermined case is when the relay node is capable of the local rerouting for some routes and is incapable of the local rerouting for other routes. Alternatively, the predetermined case is when the relay node does not support the local rerouting.

Accordingly, the IAB node 300, when being incapable of performing the local rerouting, propagates the Type 2 Indication so that the child node 300-C can also perform the local rerouting by itself, allowing the service to be quickly restored.

### Operation Example of Fourth Embodiment

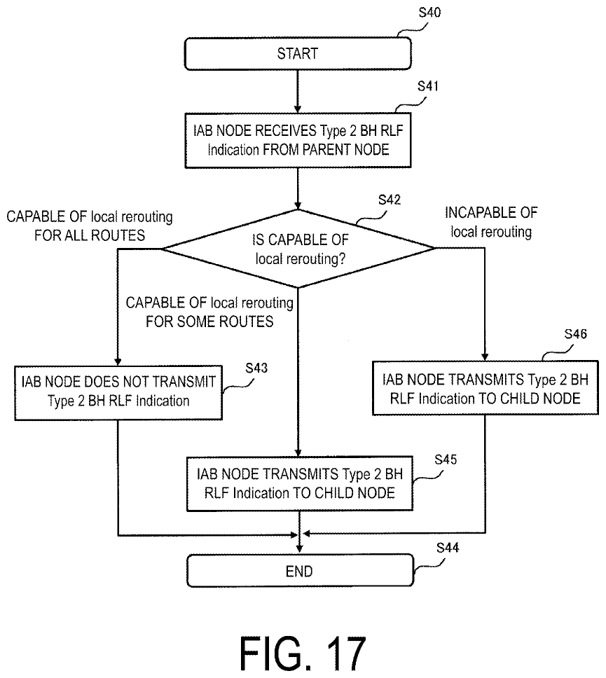

FIG. 17 is a flowchart illustrating an operation example according to the fourth embodiment.

As illustrated in FIG. 17, in step S40, the IAB node 300 starts processing.

In step S41, the IAB node 300 receives the Type 2 Indication from the parent node 300-P.

In step S42, the IAB node 300 determines whether being capable of performing the local rerouting.

First, the IAB node 300 determines whether being capable of the local rerouting for all routes other than the route in which an RLF has occurred (first determination). In other words, the IAB node 300 confirms the routing IDs of all routes other than the route in which the RLF occurred. Then, the IAB node 300 determines whether being capable of the local rerouting for all routes other than the route in which the RLF has occurred. Then, when the IAB node 300 determines to be capable of the local rerouting for all routes (“capable of local rerouting for all routes” in step S42), the processing proceeds to step S43.

Second, in the first determination, the IAB node 300 may determine to be capable of the local rerouting for some routes but to be incapable of the local rerouting for the rest of the routes. In this case (“capable of local rerouting for some routes” in step S42), the processing proceeds to step S45.

Third, in the first determination, the IAB node 300 may determine that the IAB node 300 does not support the local rerouting. In this case (“incapable of local rerouting” in step S42), the processing proceeds to step S46. When also the IAB node 300 determines to be incapable of the local rerouting for any route other than the route in which the RLF has occurred, the IAB node 300 may determine to be incapable of the local rerouting and the processing may proceed to Step S46.

In step S43, the IAB node 300 does not transmit the Type 2 Indication to the child node 300-C. In other words, the IAB node 300 does not perform the propagation of the Type 2 Indication. This is because the IAB node 300 can ensure the alternate path, and thus can transfer the data packet received from the child node 300 by using the alternate path.

In step S44, the IAB node 300 terminates a series of processing operations.

In step S45, the IAB node 300 transmits the Type 2 Indication. In other words, the IAB node 300 perform the propagation of the Type 2 Indication. The child node 300-C may perform the local rerouting in response to the reception of the Type 2 Indication.

Note that in step S45, since the local rerouting is possible for some routes, the IAB node 300 may transmit a routing ID for which the local rerouting can be performed, as the additional information, to the child node 300-C, in a manner the same as, and/or similar to in the third embodiment.

Furthermore, in step S46, the IAB node 300 transmits the Type 2 Indication to the child node 300-C. In other words, the IAB node 300 perform the propagation of the Type 2 Indication. Then, the processing proceeds to step S44.

In this way, in the fourth embodiment, in the IAB node 300, the propagation of the Type 2 Indication is performed when the IAB node 300 is capable of the local rerouting for some routes but incapable of the local rerouting for the rest of the routes. In the IAB node 300, the propagation of the Type 2 Indication is performed when the IAB node 300 does not support the local rerouting.

The fourth embodiment describes the relationship between the parent node 300-P detecting the RLF and the IAB node 300, but is also applicable to, for example, a relationship between the IAB node 300 and the child node 300-C. Further, the fourth embodiment is also applicable to a relationship between the child node 300-C and its child node (grandchild node). In other words, the propagation of the Type 2 Indication described in the fourth embodiment is applicable to each IAB node 300 constituting the topology.

### Fifth Embodiment

A fifth embodiment is described.

The fifth embodiment is also an embodiment for the propagation of the Type 2 Indication. For example, assume that the IAB node 300 receives the Type 2 Indication from the parent node 300-P of the IAB node 300. In this case, the IAB node 300 cannot confirm whether the received Type 2 Indication is one transmitted by the parent node 300-P when the parent node 300-P detecting an RLF (not propagated) or one transmitted from a further parent node of the parent node 300-P (propagated).

Therefore, in the fifth embodiment, when the IAB node 300 receives the Type 2 Indication, if the propagation of the Type 2 Indication is indicated for the received Type 2 Indication, the IAB node 300 transmits the Type 2 Indication to the child node 300-C.

Specifically, when the relay node (e.g., the IAB node 300) receives, from the parent node (e.g., the parent node 300-P), a notification indicating that a failure has occurred in a backhaul link and information indicating execution of propagation of the notification, the relay node transmits the notification to the child node (e.g., the child node 300-C).

### Operation Example of Fifth Embodiment

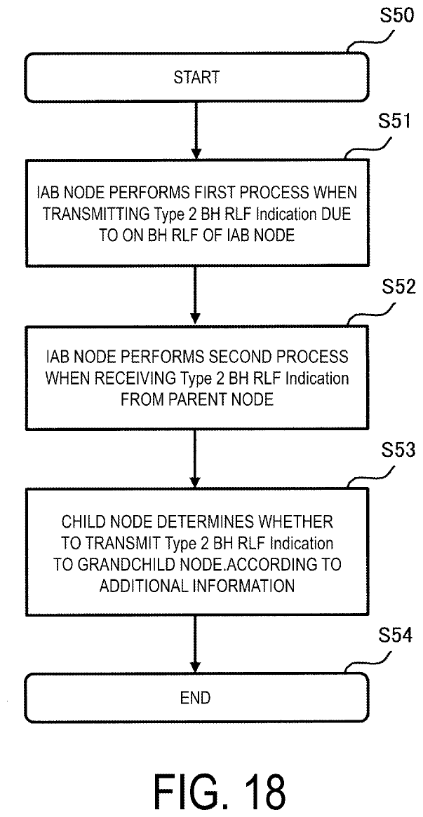

FIG. 18 is a flowchart illustrating an operation example according to the fifth embodiment.

As illustrated in FIG. 18, in step S50, the IAB node 300 starts processing.

In step S51, the IAB node 300 performs a first process when transmitting the Type 2 Indication due to an RLF in the BH link of the IAB node 300. Step S51 is an example of a case where the IAB node 300 illustrated in FIG. 14 transmits the Type 2 Indication to the child node 300-C.

The first process is any one of the following processes.

B1: No additional information is added.

B2: Information indicating that the cause is a BH RLF in the IAB node 300 is added.

B3: Information indicating, to the child node, execution of propagation is added.

For example, by way of B3, the IAB node 300 can indicate, to the child node 300-C, the propagate the Type 2 Indication. By way of B2, the IAB node 300 can notify the child node 300-C that the Type 2 Indication is one transmitted due to the RLF detection in the BH link of the IAB node 300. Thus, the IAB node 300 can notify the child node 300-C that the child node 300-C itself is the IAB node that receives the Type 2 Indication for the first time. Furthermore, by way of B1, the IAB node 300 can leave the subsequent processing to the child node 300-C without giving any particular indication or the like to the child node 300-C.

In step S52, the IAB node 300 performs a second process when receiving the Type 2 Indication from the parent node 300-P. Step S52 is an operation when the IAB node 300 receiving the Type 2 Indication from the parent node 300-P transmits the Type 2 Indication to the child node 300-C in FIG. 16, for example.

The second process is any one of the following processes.

C1: No additional information is added.

C2: Information indicating that the cause is a BH RLF in the parent node is added.

C3: Information indicating, to the child node, no execution of propagation of the Type 2 Indication is added.

For example, by way of C3, the IAB node 300 can transmit the Type 2 Indication to the child node 300-C with indicating, to the child node 300-C, that no execution of propagation of the Type 2 Indication is performed to a further child node (a grandchild node for the IAB node 300). By way of C2, the IAB node 300 can notify the child node 300-C that the Type 2 Indication is transmitted due to the RLF detected in the parent node 300-P of the IAB node 300. Furthermore, by way of C1, the IAB node 300 can leave the subsequent processing to the child node 300-C without giving any particular indication or the like to the child node 300-C.

The IAB node 300, after performing the second process, transmits the Type 2 Indication to the child node 300-C.

Note that the IAB node 300 may perform the processing of step S51 and the processing of step S52 when 1 hop propagation is configured. The configuration of 1 hop propagation may be made by, for example, the donor node 200, or may be made through Operation Administration and Maintenance (OAM).

In step S53, the child node 300-C transmits or does not transmit the Type 2 Indication to the grandchild node in accordance with the additional information. In other words, the child node 300-C performs or does not perform the propagation of the Type 2 Indication to the grandchild node according to the additional information.

Then, in step S54, the child node 300-C terminates a series of processing operations.

### OTHER EMBODIMENTS

A program causing a computer to execute each of the processes performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM.

Circuits for executing the processes to be performed by the UE 100 or the gNB 200 may be integrated, and at least part of the UE 100 or the gNB 200 may be configured as a semiconductor integrated circuit (a chipset or an SoC).

The phrases “based on” and “depending on” used in the present disclosure do not mean “based only on” and “only depending on,” unless specifically stated otherwise. The phrase “based on” means both “based only on” and “based at least in part on”. Similarly, the phrase “depending on” means both “only depending on” and “at least partially depending on”. “Obtain” or “acquire” may mean to obtain information from stored information, may mean to obtain information from information received from another node, or may mean to obtain information by generating the information. The terms “include”, “comprise” and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

Although embodiments have been described in detail with reference to the drawings, a specific configuration is not limited to those described above, and various design modifications and the like can be made without departing from the scope of the present disclosure. All of or a part of the embodiments can be combined together as long as no inconsistencies are introduced.

### Supplementary Note

### INTRODUCTION

In RAN2 #114e, Enhancements to Integrated Access and Backhaul for NR (eIAB) has reached the following agreement for topology adaptation enhancements.

The RAN2 preference is to support inter-topology routing by rewriting the BAP header based on the BAP routing ID in option 4.

Assume that the IAB donor configures an (alternative) egress link that can be used for local rerouting (at least for the same destination, the same routing ID, further consideration is needed).

Local rerouting based on flow control feedback is allowed based on a specific value of the available buffer size. For the details, further studies are required. The current hbh fc is for DL traffic.

The NR DLInformationTransfer and ULInformationTransfer messages can be extended to transfer F1-C related packets in CP/UP separation.

In order to transfer F1-C related packets in the NR RRC message, a new IE called DedicatedInfoF1c may be defined.

F1-C over RRC and F1-C over BAP should not be supported simultaneously in the same parent link.

A trigger for generating the Type 2 Indication is when the RLF is detected. Further study is required for both cases of single connectivity and dual connectivity.

A trigger for transmitting the Type 3 RLF Indication is a normal recovery after BH RLF. Further study is required for both cases of single connectivity and dual connectivity.

The Type 2 and Type 3 BH RLF Indications are transmitted through a BAP Control PDU.

Even upon receiving the Type 2 Indication, the IAB node does not initiate RRC re-establishment.

When the IAB node with two parent nodes via DC receives a Type 2 BH RLF indication from one parent node, the IAB node may trigger local rerouting to the other parent node. Further study is required for details of local rerouting and whether an operation at the time of Type 2 Indication can be configured.

This Supplementary Note describes details of Type 2/3 BH RLF Indication and local rerouting.

### DISCUSSION

### Type 2/3 BH RLF Indication

### Type 2 Indication for Dual Connectivity

RAN2 agreed that “the trigger for generating the Type 2 Indication is when an RLF is detected, and further study is required for both cases of single connectivity and dual connectivity”. For the single connection with a parent node, the agreement is very easy. On the other hand, for dual connectivity with two parent nodes, how the Type 2 Indication is transmitted should be further discussed.

RAN2 #113-e agreed on the use case of a Type 2 Indication from the viewpoint of the child node as follows.

RAN2 supports the Type 2/3 RLF Indication (further study is required for effects and details of defined operation TS).

The Type 2 RLF Indication can be used to trigger local rerouting.

The Type 2 RLF Indication can be used to trigger deactivation of IAB supported by SIBs.

The Type 2 Indication may be used to trigger deactivation or reduction of SR and/or BSR transmission.

In the above context, the operation can be considered to be that the child node receiving the Type 2 Indication is expected to not transfer the upstream packet to the IAB node transmitting the Type 2 Indication due to the BH RLF in the IAB node. This is consistent with the agreement that “when the IAB node with two parent nodes (via DC) receives a Type 2 BH RLF indication from one parent node, the IAB node may trigger local rerouting to the other parent node”.

Observation 1: The child node can sometimes not be expected to transfer upstream packets to the IAB node transmitting the Type 2 BH RLF Indication.

When the IAB node has dual connectivity, Observation 1 is not always correct because local rerouting may be performed as a Rel-16 operation.

NOTE: data buffering in a transmission part of a BAP entity is up to the implementation (for example, until an RLC-AM entity receives an acknowledgment response). For a BH RLF, the transmitter of the BAP entity can reroute, to the alternative path, the BAP data PDU unacknowledged by the lower layers before the BH RLF.

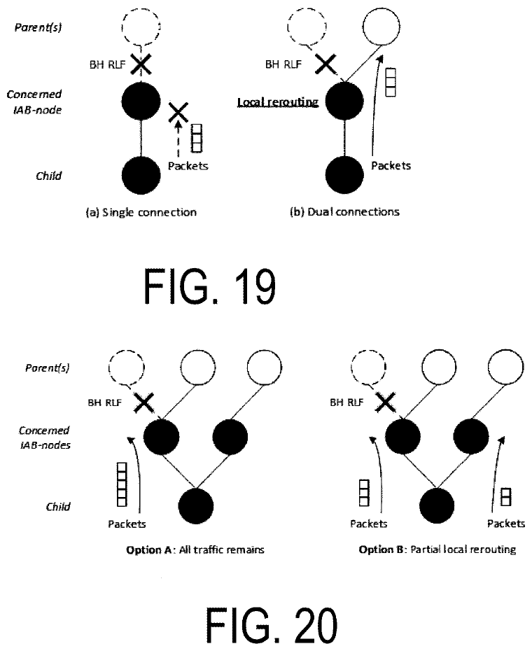

FIG. 19 illustrates two cases of upstream packet transferring as seen from a child node.

Therefore, when an alternative path exists even after the BH RLF of the MCG, it remains questionable whether the IAB node should transmit the Type 2 Indication. It should be noted that, during the MCG failure information procedure, the IAB node can continue local rerouting.

Observation 2: The child node can transfer upstream packets when the parent node (the IAB node) can perform local rerouting, i.e., due to dual connectivity.

Another scenario of EN-DC is also worth considering. In EN-DC, the MCG link (i.e., MeNB) is only used for control plane signaling, and data is always transferred via the SCG link (i.e., SgNB). In this case, since packet transferring of an SCG RLF child node is directly affected, the IAB node needs to transmit the Type 2 indication to the child node. On the other hand, the MCG RLF (LTE link) is considered not having to trigger the Type 2 Indication because the SCG link is available in the subsequent RRC connection re-establishment procedure.

Observation 3: In EN-DC, since the parent node (the IAB node) cannot perform local rerouting via the MCG (LTE link), the parent node needs to notify the child node of the SCG RLF (i.e., NR link) by way of the Type 2 BH RLF Indication.

From the above, in the IAB node with dual connectivity, when the RLF is detected in either the MCG or the SCG, the following options are conceivable.
Option 1: The IAB node does not transmit the Type 2 Indication when an alternative path for local rerouting exists.
Option 2: The IAB node transmits a Type 2 Indication together with information that an alternative path exists.

Both options have the same intended outcome. In other words, the child node can transfer the upstream packets to the IAB node. However, depending on what the child node does based on reception of the Type 2 Indication, option 2 is expected to provide an option for better overall topology management, such as “partial” local rerouting as described below. Therefore, RAN2 needs to discuss which option is preferable from the viewpoint of the child node.

Proposal 1: When the IAB node can perform local rerouting after the BH RLF declaration, RAN2 needs to discuss whether the Type 2 BH RLF Indication is not transmitted (i.e., option 1) or is transmitted together with the additional information such as “alternate path is available” (i.e., option 2).

### Type 2 Adapted Donor Controllability

The most promising use case in the Type 2 Indication is that the child node performs local rerouting, as agreed in RAN2. RAN2 #114-e discussed the combined use of Type 2 and Type 4. This is because, in the Type 4 Indication, the child node declares BH RLF and local rerouting is finally performed in a manner the same as, and/or similar to in Rel-16. Some companies have indicated that local rerouting upon receiving the Type 2 is configurable by the donor. It makes sense because the donor manages the topology-wide objectives and knows the current performance of the entire topology.

Proposal 2: RAN2 needs to agree that the donor configures the IAB node regarding whether to perform local rerouting upon receiving the Type 2 BH RLF Indication.

The donor needs to be allowed to configure the IAB node regarding whether to transmit a Type 2 Indication when a BH RLF is detected. For example, when the IAB node implements Rel-17 and its child nodes support only Rel-16, i.e., when a “mixed” arrangement is used, the donor can turn it off.

Proposal 3: RAN2 needs to agree that the donor configures the IAB node regarding whether to transmit a Type 2 BH RLF Indication when a BH RLF is detected.

### Partial Local Rerouting Due to Type 2 Indication

When the parent node (the IAB node) detects a BH RLF but can still perform local rerouting, the child node with dual connectivity actually has the following two operation options, as illustrated in FIG. 19.
Option A: All upstream traffics remain at this parent node and no local rerouting is performed at the child node.
Option B: “Partial” local rerouting that causes another parent node to reroute some of the upstream traffics.

Option A is simple and pertains to only a behavior of the child node when option 1 above is selected. However, the BH RLF causes the parent node to lose either the MCG or the SCG link, which may lead to overload of the parent node.

Option B is enabled by option 2 above and can distribute the load to two parent nodes of the child node. Therefore, option B is expected to function to improve the performance of the entire topology.

Observation 4: When the IAB node with dual connectivity transmits a Type 2 BH RLF Indication together with some information (i.e., option 2 of proposal 4), the child node may have an option when “partial” local rerouting is performed for better load distribution (i.e., option B).

When option B is desirable, there are further two additional options for the child node to perform partial local rerouting.
Option B1: The child node locally decides which traffic to route to another parent node based on the additional information in the Type 2 Indication, such as the congestion status of the parent node (the IAB node).
Option B2: The donor configures the child node regarding which traffic to route to another parent. For example, when the Type 2 Indication notifies the child node of the MCG RLF of the parent node, the donor configures the IAB node in advance with the list routing ID for partial local rerouting.

The option B1 is a distribution type scheme by each IAB node and the option B2 is a centralization type scheme by the donor. The option B1 may be able to follow dynamic variations in load on the route and the option B2 may be a semi-static optimization. Considering that the topology-wide objectives are governed by the donor, an option B2 seems to be somewhat desirable.

Proposal 4: RAN2 needs to discuss whether to perform “partial” local rerouting in the child node (i.e., option B) when the parent node with dual connectivity experiences a BH RLF.

FIG. 20 illustrates a pair of operations of a child node without local rerouting and a child node with partial local rerouting.

Indication in Type 3 single and dual connectivity case

RAN2 agreed that “the trigger for transmitting the Type 3 RLF Indication is a normal recovery after the BH RLF. Further study is required for both cases of single connectivity and dual connectivity.” A common understanding for Type 3 Indication is considered to restore the behavior of the child node initiated by the reception of the Type 2 Indication. Therefore, the Type 3 Indication is effective only when the child node receives the Type 2 Indication. Such a condition of the Type 3 indication may be commonly applied to both the single connectivity and dual connectivity since only the Type 2 indication depends on these cases, for example, as in Proposal 1 above.

Proposal 5: RAN2 should agree that the Type 2 BH RLF Indication is transmitted only when the Type 3 BH RLF Indication is transmitted, in addition to the agreed operation when the BH RLF is successfully recovered, as common to the cases of the single connectivity and dual connectivity.

### Propagation of Type 2 Indication

The propagation of the Type 2 Indication aims to provide better topology management, such as load distribution and reduced service interruption.

Specifically, various proposals have been made by respective companies. One option is to transfer the Type 2 Indication when the IAB node receives the Type 2 Indication and no alternate path exists. This is mainly consistent with the operation of the IAB node in option 1 of proposal 1. In other words, it can be interpreted that the IAB node does not perform local rerouting, including the partial local rerouting of Proposal 4. Another option is to limit the propagation of the Type 2 Indication to one hop, which is expected for stable topology management. Of course, it depends on how the Type 2 Indication with dual connectivity is transmitted (i.e., Proposal 1, whether to consider “partial” local rerouting in the child node or not, i.e., Proposal 4). For the details, further studies are required.

Proposal 6: RAN2 should agree that the propagation of the Type 2 Indications to descendant nodes is supported. For detailed conditions, such as transferring only when the IAB node does not perform local rerouting, further studies are required.

Disabling or Reducing SR or BSR by Type 2 Indication RAN2 agreed that “Type 2 Indication can be used as a trigger for disabling or reducing SR and/or BSR transmission”, but how to handle this agreement is not discussed. Since it is considered to be the operation of the IAB-MT, clear definition may be required. For deactivation or reduction, “deactivation” may be simpler from a specification point of view. However, this means that SR and BSR can only be transmitted after receiving the Type 3 Indication, which may cause scheduling delay. On the other hand, although “reduction” may cause unnecessary interference, scheduling may be resumed immediately after the BH link is recovered. Therefore, RAN2 needs to discuss whether to support one or both of “deactivation” and “reduction” of SR and/or BSR. When both are supported, this should be configurable by the IAB donor. When supporting “reduction”, how to handle the reduction of SR and/or BSR is unclear. The concept of the prohibit timer may be reused, but further studies are needed at this time.

Proposal 7: RAN2 should agree to define that the IAB-MT deactivates or reduces SR and/or BSR transmission upon receiving a Type 2 BH RLF Indication.

Proposal 8: RAN2 needs to discuss whether one or both of “deactivation” and “reduction” of SR and BSR is supported (i.e., configurable) upon receiving a Type 2 BH RLF Indication.

### Local Rerouting

### Alternate Path Configuration by Donor

In Rel-16, local rerouting is allowed only when a BH RLF occurs to cover both the BH RLF of a BH link thereof and a BH RLF of a BH link of the parent node (i.e., when a Type 4 Indication is received). It is up to the IAB-MT to determine which path is to be used as an alternative path at the time of local rerouting among a plurality of routes having the same destination configured by the IAB donor.

To transmit a BAP data PDU, the BAP entity performs the following.

Otherwise, when the BAP address is consistent with the destination field, the BAP path ID is the same as the path field, and there is an entry in the BH routing configuration available for the egress link corresponding to the next hop BAP address,
Select the egress link corresponding to the next hop BAP address of the entry.

NOTE 1: When the link is in a BHRLF, the egress link is not considered to be available.

NOTE 2: For each combination of BAP address and BAP path ID, a maximum of one entry is required for the BH routing configuration. There may be a plurality of entries having the same BAP address in the BH routing configuration.
Otherwise, when the BAP address is consistent with the destination field and there is at least one entry in the BH routing configuration available for the egress link corresponding to the next hop BAP address,
From the BH routing configuration, select the entry available to the egress link corresponding to the next hop BAP address, such that the BAP address is the same as the destination field.
Select the egress link corresponding to the next hop BAP address in the entry selected above.

On the other hand, for local rerouting in Rel-17, RAN2 #114-e agreed that “it is assumed that the IAB donor configures an (alternative) egress link that can be used for local rerouting (at least for the same destination, the same routing ID, further consideration is needed).” In consideration of the agreement of RAN2 #112-e that “RAN2 discusses local rerouting, including its advantages over central routing decision and how to be able to address the overall topology goals”, the IAB donor needs to have more controllability over local rerouting in terms of alternate path configuration compared to the Rel-16 mechanism. For example, since the IAB donor knows which route is congested depending on the number of UE bearers aggregated in the BH RLC channel or the like, the IAB donor may want the IAB node to select another route as an alternative path at the time of local rerouting. In this case, the IAB donor can explicitly configure a specific alternate path for the IAB node and the IAB node must follow the configuration upon local rerouting. In this case, in the BH routing configuration, a specific alternative route (=for local rerouting) is associated with a normal route (=for normal routing). It should be noted that the Rel-16 mechanism is applicable even when the IAB donor does not configure a specific alternate path for the IAB node.

Proposal 9: RAN2 needs to agree that the IAB donor can configure, for the IAB node, a specific alternate path for local rerouting associated with each normal route.

When proposal 9 is agreed upon, the IAB node performing local rerouting may rewrite the BAP header, even for intra-topology local rerouting, in a manner the same as, and/or similar to the agreed inter-topology routing, i.e., option 4. This makes it possible to indicate the path of the entire topology, not just one egress link, for locally rerouted packets.

Proposal 10: when proposal 9 is agreed upon, RAN2 also needs to agree that the rewriting of the BAP header also applies to intra-topology local rerouting, in a manner the same as, and/or similar to the inter-topology routing option 4.

### Local Rerouting Command by Donor

As another aspect of the IAB donor controllability, it needs to be counted that the IAB donor can recognize local rerouting and the IAB node can start/stop the local rerouting for coexistence of the local rerouting and topology-wide objectives. For example, when the IAB donor finds that the topology-wide objectives cannot be achieved, the IAB donor may instruct the IAB node to start/stop local rerouting, or load distribution between the routes. How to handle the topology-wide objectives through the local rerouting fully depends on the implementation of the IAB donor, but the IAB donor may need information and controllability of the local determination of the IAB node.

Proposal 11: RAN2 needs to study whether the IAB node needs to notify the IAB donor when local rerouting is started/stopped.

Proposal 12: RAN2 needs to discuss whether the IAB donor can instruct the IAB node to start/stop local rerouting for load distribution between the routes.

1. A communication control method used in a cellular communication system, the communication control method comprising steps of:
detecting, by a relay node, an occurrence of a failure in a backhaul link between the relay node and one of parent nodes of a first parent node and a second parent node, the relay node being configured with dual connectivity for the first parent node and the second parent node; and
transmitting, by the relay node, a notification relating to detection of the failure to a child node of the relay node, when the relay node is not capable of uplink rerouting; wherein
the transmitting the notification relating to detection of the failure is conducted when the relay node operates in EN-DC and the failure in the backhaul link is occurred between the second parent node and the relay node forming the backhaul link with the second parent node.

2. The communication control method according to claim 1, wherein the transmitting the notification relating to detection of the failure from the relay node to the child node when an RRC reestablishment processing is started.

3. The communication control method according to claim 1, wherein the occurrence of a failure in the backhaul link is caused by an expiration of a timer that starts after detecting a radio link failure.

4. The communication control method according to claim 1, wherein the notification indicates that the relay node is attempting to recover from the failure.

5. The communication control method according to claim 1, further comprising:
performing, by the child node, local rerouting of upstream traffic, when the child node receives the notification from the relay node.

6. The communication control method according to claim 1, further comprising:
transmitting, by the child node, the notification to a child node of the child node, when the child node receives the notification from the relay node and satisfies a predetermined condition.

7. The communication control method according to claim 6, wherein the predetermined condition is:
when the child node is capable of local rerouting for some paths and is incapable of local rerouting for other paths; or
when the child node does not support local rerouting.

8. The communication control method according to claim 6, wherein the predetermined condition is when the relay node transmits information indicating execution of propagation of the notification along with the notification relating to detecting the failure.

9. The communication control method according to claim 1, wherein the notification relating to detection of the failure is not transmitted when the failure occurs between the relay node and the first parent node where the first parent node is a Long Term Evolution (LTE) node providing an Evolved Universal Terrestrial Radio Access (E-UTRA) service, and the second parent node is a New Radio (NR) node providing a NR service.

10. The communication control method according to claim 1, further comprising transmitting additional information relating to the notification in addition to the transmitting the notification relating to detecting the failure.

11. The communication control method according to claim 10, wherein
the additional information includes one of:
information indicating whether the relay node is capable of local rerouting;
information indicating whether the child node is to perform local rerouting;
information indicating in which one of a first backhaul link and a second backhaul a failure has occurred, or information indicating which one of the first backhaul link and the second backhaul link is available, the first backhaul link being between a first parent node managing a master cell group and the relay node, the second backhaul link being between a second parent node managing a secondary cell group and the relay node;
information indicating an available routing ID or information indicating an unavailable routing ID; and
information indicating quality of an available link.

12. A relay node comprising transceiver circuitry and processing circuitry operatively associated with the transceiver circuitry and configured to execute processes of:
detecting, by a relay node, an occurrence of a failure in a backhaul link between the relay node and one of parent nodes of a first parent node and a second parent node, the relay node being configured with dual connectivity for the first parent node and the second parent node; and
transmitting, by the relay node, a notification relating to detection of the failure to a child node of the relay node, when the relay node is not capable of uplink rerouting; wherein
the transmitting the notification relating to detection of the failure is conducted when the relay node operates in EN-DC and the failure in the backhaul link is occurred between the second parent node and the relay node forming the backhaul link with the second parent node.

13. The relay node according to claim 12, wherein the transmitting the notification relating to detection of the failure from the relay node to the child node when an RRC reestablishment processing is started.

14. The relay node according to claim 12, wherein the occurrence of a failure in the backhaul link is caused by an expiration of a timer that starts after detecting a radio link failure.

15. The relay node according to claim 12, wherein the notification indicates that the relay node is attempting to recover from the failure.

16. The relay node according to claim 12, wherein the notification relating to detection of the failure is not transmitted when the failure occurs between the relay node and the first parent node where the first parent node is a Long Term Evolution (LTE) node providing an Evolved Universal Terrestrial Radio Access (E-UTRA) service, and the second parent node is a New Radio (NR) node providing a NR service.

17. The relay node according to claim 12, further configured to execute processes of transmitting additional information relating to the notification in addition to the transmitting the notification relating to detecting the failure.

18. A cellular communication system comprising a relay node, wherein the relay node includes transceiver circuitry and processing circuitry operatively associated with the transceiver circuitry and configured to execute processes of:
detecting, by a relay node, an occurrence of a failure in a backhaul link between the relay node and one of parent nodes of a first parent node and a second parent node, the relay node being configured with dual connectivity for the first parent node and the second parent node; and
transmitting, by the relay node, a notification relating to detection of the failure to a child node of the relay node, when the relay node is not capable of uplink rerouting; wherein
the transmitting the notification relating to detection of the failure is conducted when the relay node operates in EN-DC and the failure in the backhaul link is occurred between the second parent node and the relay node forming the backhaul link with the second parent node.

19. A non-transitory computer readable storage medium storing a program including processes of:
detecting, by a relay node, an occurrence of a failure in a backhaul link between the relay node and one of parent nodes of a first parent node and a second parent node, the relay node being configured with dual connectivity for the first parent node and the second parent node; and
transmitting, by the relay node, a notification relating to detection of the failure to a child node of the relay node, when the relay node is not capable of uplink rerouting; wherein
the transmitting the notification relating to detection of the failure is conducted when the relay node operates in EN-DC and the failure in the backhaul link is occurred between the second parent node and the relay node forming the backhaul link with the second parent node.

20. A chipset comprising circuitries configured to execute processes of:
detecting, by a relay node, an occurrence of a failure in a backhaul link between the relay node and one of parent nodes of a first parent node and a second parent node, the relay node being configured with dual connectivity for the first parent node and the second parent node; and
transmitting, by the relay node, a notification relating to detection of the failure to a child node of the relay node, when the relay node is not capable of uplink rerouting; wherein
the transmitting the notification relating to detection of the failure is conducted when the relay node operates in EN-DC and the failure in the backhaul link is occurred between the second parent node and the relay node forming the backhaul link with the second parent node.
